(19) United States
(12) Patent Application Publication
(10) Pub. No.: US 2026/0340561 A1
(43) Pub. Date: Oct. 29, 2026

(54) AI-Driven Personal Branding and Career Development Platform for Identity-Based Growth

(71) Applicant: Andre Ramsey, Ellwood City, PA (US)

(72) Inventor: Andre Ramsey, Ellwood City, PA (US)

(21) Appl. No.: 19/187,994

(22) Filed: Apr. 23, 2025

(51) Int. Cl. G06Q 10/0639; A63F 13/79; G06Q 10/40

(52) U.S. Cl. CPC G06Q 10/06393; A63F 13/79; G06Q 10/40

(57) ABSTRACT

A modular, AI-powered platform for personal brand development and career alignment that uses proprietary assessments, dynamic scoring, and real-time feedback to help individuals—particularly student-athletes—build a data-driven, personality-aligned brand strategy. A custom score engine, adaptive content logic, and gamified user engagement drive sustainable personal growth.

### CROSS-REFERENCE TO RELATED APPLICATIONS

This non-provisional patent application should be cross-referenced with the provisional patent application submitted on Apr. 23, 2024, Application No. 63/637,867, with the Title of Invention of Personal Branding Technology Based on Personality, Communication Style, and Skills to Connect People to Opportunities and Support.

### BACKGROUND OF THE INVENTION

The current NIL (Name, Image, Likeness) landscape is dominated by transactional marketplaces that focus almost entirely on short-term brand deals and monetization. While these platforms connect athletes to sponsorship opportunities, they do little to support the long-term development of the person behind the athlete. Most existing tools rely on static social media metrics or highlight reels, offering little insight into identity, motivation, or potential beyond the field.

There is no unified system designed to develop the whole human—one that considers an athlete's personality, communication style, learning habits, mental wellness, and long-term career alignment. As a result, athletes are left to navigate their brands and futures alone, without structured tools or support systems.

This invention addresses that gap by integrating AI-driven assessments, personalized branding, adaptive learning, and gamified feedback into one holistic platform. It empowers athletes not just to earn, but to evolve—reframing NIL from a moment of monetization to a lifelong identity-building journey.

The invention relates to artificial intelligence, gamification systems, and user profiling technology, specifically applied to branding and identity development through career-aligned scoring and analytics.

### BRIEF SUMMARY OF THE INVENTION

The platform includes a personality-based assessment (APA), a weighted brand score engine, adaptive learning modules, gamification elements, and an AI-recommendation system that helps student-athletes align their personal brand with their future goals. The platform is modular and customizable, allowing for long-term development aligned with the individual's identity and communication style.

### BRIEF DESCRIPTION OF THE SEVERAL VIEWS OF THE DRAWING

FIG. 1A contains a flowchart showcasing how inputs lead to brand score system, AI function, and the gamification engine lead to career alignment logic, adaptive scoring model, and real-time feedback system.

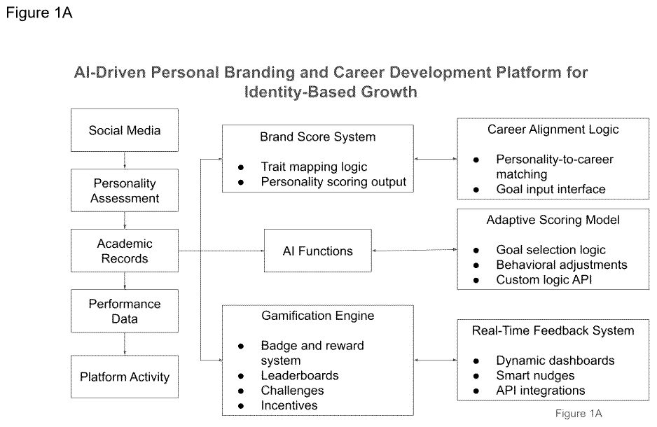

### DETAILED DESCRIPTION OF THE INVENTION

### 1. Brand Score System

1.1. Weight Assignment Logic—Allows dynamic or user-defined weighting across seven categories.
1.2. Data Sources—Pulls from social platforms, academic records, sports performance logs, and internal activity.
1.3. Real-Time Score Calculation—Computes a normalized brand score using goal-sensitive, weighted formulas.
1.4. Output Visualization—Real-time dashboard provides progress snapshots, score trends, and key focus areas.

### 2. Athlete Personality Assessment (APA)

2.1. Assessment Structure—A multi-section questionnaire modeled on established behavioral frameworks.
2.2. Trait Mapping Logic—Identifies branding-relevant personality traits: tone, motivation, leadership style.
2.3. Personality Scoring Output—Outputs an alignment profile linked to communication styles and brand categories.
2.4. Branding Insights Mapping—Suggests brand tone, content themes, and strategy based on identity match.

### 3. Career Alignment Logic

3.1. Personality-to-Career Matching—Aligns user data with predefined branding and career categories.
3.2. Goal Input Interface—Users select or adjust future goals to trigger tailored system updates.
3.3. AI Matching Engine—Suggests career-aligned mentors, NIL tracks, and brand opportunities.
3.4. Output—Provides development roadmap with learning modules and milestone checkpoints.

### 4. Adaptive Scoring Model

4.1. Goal Selection Logic—Score weighting shifts based on selected growth trajectory (e.g., influencer, coach).
4.2. Behavioral Adjustments—AI detects trends in user activity to realign focus areas dynamically.
4.3. Custom Logic API—Schools, teams, or institutions may deploy their own scoring rules over the core framework.

### 5. Gamification Engine

5.1. Badge and Reward System—Badges unlocked through consistent learning, branding activity, and goal tracking.
5.2. Leaderboards—Rankings encourage healthy competition across engagement and score growth.
5.3. Challenges—AI and peer-created challenges prompt brand storytelling, consistency, or outreach tasks.
5.4. Incentives—Progress unlocks recognition, resources, and feature opportunities.

### 6. Real-time Feedback System

6.1. Dynamic Dashboards—Score status, category insights, and recommended next actions update in real-time.
6.2. Smart Nudges—AI notifications guide user engagement when behavior deviates from goal pathway.
6.3. API Integrations—Third-party data sources enrich tracking and deepen brand intelligence insights.

### 7. System Extensibility

7.1. Modular Configurations—Admins can adjust branding pillars, score weights, and challenge mechanics.
7.2. Persona Templates—Preloaded branding archetypes help athletes benchmark and personalize their path.
7.3. Long-Term Scalability—Platform architecture allows the addition of new features or domains in future iterations.

### Preferred Real-World Embodiments

“Jordan,” a 17-year-old completes the APA (Athlete Personality Assessment) and finds that she is a Type 3 (“Top Performer”) athlete. The system identifies her drive for recognition and high achievement, recommending content focused on game-day highlights, awards, and motivational messaging. Her brand score places strong emphasis on social engagement and brand consistency. As her academic performance grows, the AI reweights her score toward scholar-athlete alignment, recommending new NIL opportunities. She earns badges for a content streak and completes storytelling challenges, triggering AI-suggested pitches to relevant sportswear sponsors. As her nonprofit volunteer work expands, she also aligns that work with her personality, and her social media content and personal branding content continue to get more and more authentic to her-earning the attention of a national non-profit organization to work with her on an NIL deal as well as her first job after college.

### Alternative Embodiments

While the system is currently configured for student-athletes within the NIL space, its modular design and architecture are intentionally flexible. The underlying engines for scoring, feedback, identity mapping, and goal alignment can be adapted for other domains where personal growth, branding, or long-term alignment are essential. Future implementations may explore applications in environments that value individual development, storytelling, and career readiness—without being limited to athletics. These embodiments can be utilized in but not limited to the creative space for musicians, artists, fashion designers, as well as entrepreneurs.

### Conclusion

This invention addresses a critical gap in the NIL ecosystem: the lack of human-first, identity-driven platforms for long-term brand development. By integrating psychology, AI, and gamification into a cohesive system, this platform empowers athletes to build meaningful, sustainable brands aligned with who they are—not just what they do.

1. A system for generating personalized branding strategies, comprising: a personality assessment engine; an AI module for interpreting assessment output and generating brand strategy; a real-time score engine with dynamic weights based on goal selection; and a gamified feedback loop system.

2. The system of claim 1, wherein said score includes seven customizable weighted dimensions.

3. The system of claim 1, wherein said personality output determines suggested brand tone and platform usage.

4. The system of claim 1, further comprising career alignment recommendations mapped via AI logic.

5. The system of claim 1, wherein said feedback loop ingests external data via platform APIs.

6. The system of claim 1, wherein gamification is tied to learning modules, habits, and peer-led challenges.

7. The system of claim 1, wherein the platform is modular and can be reconfigured by external administrators.
